(19) United States
(12) Patent Application Publication
(10) Pub. No.: US 2014/0057124 A1
(43) Pub. Date: Feb. 27, 2014

(54) Corrosion And Wear-Resistant Claddings

(71) Applicants: Piyamanee Komolwit, Greensburg, PA (US); Qingjun Zheng, Export, PA (US); Jim Faust, New Albany, IN (US)

(72) Inventors: Piyamanee Komolwit, Greensburg, PA (US); Qingjun Zheng, Export, PA (US); Jim Faust, New Albany, IN (US)

(73) Assignee: Kennametal Inc., Latrobe, PA (US)

(21) Appl. No.: 13/594,262

(22) Filed: Aug. 24, 2012

(51) Int. Cl. B32B 15/01; B32B 15/02; B05D 3/02

(52) U.S. Cl. 428/553; 427/201

(57) ABSTRACT

In one aspect, composite articles are described herein comprising wear-resistant claddings demonstrating improved corrosion resistance. A composite article described herein, in some embodiments, comprises a metal or alloy substrate and a cladding adhered to the substrate, the cladding comprising cemented carbide particles and an alloying additive dispersed in a nickel-based alloy matrix, wherein the alloying additive comprises at least one of copper and molybdenum.

### FIELD

The present invention relates to claddings and, in particular, to claddings having improved corrosion resistance and methods of manufacturing the same.

### BACKGROUND

Wear and corrosion are two factors that operate to decrease the service life of equipment. One solution for increasing the wear resistance of equipment and tools is the application of wear-resistant coatings on outer surfaces of the equipment and tools for additional protection. While such coatings assist in increasing the service life of equipment from wear conditions, the equipment remains susceptible to reduced service life due to exposure to corrosive environments. Highly corrosive environments, such as acidic environments, can degrade or compromise coating structure, leading to premature failure and inadequate equipment protection.

### SUMMARY

In one aspect, composite articles are described herein comprising wear-resistant claddings demonstrating improved corrosion resistance. A composite article described herein, in some embodiments, comprises a metal or alloy substrate and a cladding adhered to the substrate, the cladding comprising cemented carbide particles and an alloying additive dispersed in a nickel-based alloy matrix, wherein the alloying additive comprises at least one of copper and molybdenum. In some embodiments, the alloying additive comprises both copper and molybdenum. Additionally, in some embodiments, the cemented carbide particles are tungsten carbide particles comprising cobalt binder.

In another aspect, a composite article described herein comprises a metal or alloy substrate and a cladding adhered to the substrate, the cladding comprising a hard particle component and an alloying additive of copper dispersed in a nickel-based alloy matrix, wherein the copper is present in the cladding in an amount ranging from 3.4 weight percent to 15 weight percent. Alternatively, in some embodiments, copper is present in the cladding in an amount ranging from 0.1 weight percent to 0.8 weight percent. The alloying additive, in some embodiments, further comprises molybdenum. Molybdenum can be present in the cladding in an amount ranging from 0.1 to 1.7 weight percent or from 4.5 to 15 weight percent.

In another aspect, a composite article described herein comprises a metal or alloy substrate and a cladding adhered to the substrate, the cladding comprising a hard particle component and an alloying additive of molybdenum dispersed in a nickel-based alloy matrix, wherein molybdenum is present in the cladding in an amount ranging from 4.5 to 15 weight percent. Alternatively, in some embodiments, molybdenum is present in the cladding in an amount ranging from 0.1 to 1.7 weight percent. The alloying additive, in some embodiments, further comprises copper. Copper can be present in the cladding in an amount ranging from 0.1 to 0.8 weight percent or from 3.4 to 15 weight percent.

A hard particle component of claddings described herein can comprise particles of carbides, nitrides, carbonitrides or borides or mixtures thereof. In some embodiments, for example, a hard particle component comprises particles of metal carbides, metal nitrides, metal carbonitrides, metal borides or mixtures thereof.

Claddings of composite articles described herein, in some embodiments, are brazed to the metal or alloy substrate. Claddings described herein, in some embodiments, are metallurgically bonded to the metal or alloy substrate.

In another aspect, methods of making composite articles are described herein. In some embodiments, a method of making a composite article comprises providing a metal or alloy substrate and positioning over a surface of the substrate a particulate composition comprising a hard particle component, a nickel-based alloy matrix precursor and an alloying additive disposed in a carrier. The particulate composition is heated to provide a cladding adhered to the metal or alloy substrate, the cladding comprising the hard particle component and alloying additive dispersed in a nickel-based alloy matrix, wherein the alloying additive comprises at least one of copper and molybdenum. In some embodiments, the alloying additive comprises copper and molybdenum.

In another aspect, a method of making a composite article comprises providing a metal or alloy substrate, positioning over a surface of the substrate a particulate composition comprising a hard particle component and an alloying additive disposed in a carrier and positioning over the particulate composition a nickel-based alloy matrix precursor composition. The particulate composition and the nickel-based alloy matrix precursor composition are heated to provide a cladding adhered to the metal or alloy substrate, the cladding comprising the hard particle component and alloying additive dispersed in a nickel-based alloy matrix, wherein the alloying additive comprises at least one of copper and molybdenum. In some embodiments, the alloying additive comprises copper and molybdenum.

These and other embodiments are described in greater detail in the detailed description which follows.

### BRIEF DESCRIPTION OF THE DRAWINGS

FIG. 1 is a cross-section metallography of a composite article according to one embodiment described herein.

FIG. 2 illustrates metal compositional parameters of a bulk portion of a cladding according to one embodiment described herein.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

### I. Composite Articles

In one aspect, composite articles are described herein comprising wear-resistant claddings demonstrating improved corrosion resistance. A composite article described herein, in some embodiments, comprises a metal or alloy substrate and a cladding adhered to the substrate, the cladding comprising cemented carbide particles and an alloying additive dispersed in a nickel-based alloy matrix, wherein the alloying additive comprises at least one of copper and molybdenum.

Turning now to components of articles, a composite article described herein comprises a metal or alloy substrate. In some embodiments, substrates comprise nickel metal, nickel-based alloys, iron-based alloys, cobalt metal, cobalt-based alloys or other alloys. Substrates, in some embodiments, comprise cast iron, low-carbon steels, alloy steels, tool steels or stainless steels, both wrought and castings. In some embodiments, nickel alloy substrates commercially available under the INCONEL®, HASTELLOY® and/or BALCO® trade designations. Cobalt alloy substrates, in some embodiments, are commercially available under the trade designation STELLITE® and/or MEGALLIUM®.

Moreover, substrates can comprise various geometries. In some embodiments, a substrate has a cylindrical geometry, wherein the inner diameter (ID) surface, outer diameter (OD) surface or both are provided with a cladding described herein. In some embodiments, for example, substrates comprise boiler piping or piping/tubes subject to harsh environmental conditions, including high erosion and acidic conditions. Substrates, in some embodiments, comprise bearings, extruder barrels, extruder screws, flow control components, valves, roller cone bits or fixed cutter bits.

A composite article described comprises a cladding adhered to the substrate, the cladding comprising cemented carbide particles and an alloying additive dispersed in a nickel-based alloy matrix, wherein the alloying additive comprises at least one of copper and molybdenum. Nickel-based alloys suitable for providing the matrix, in some embodiments, have compositional parameters derived from Table I.

TABLE I
Ni-Based Alloy Compositional Parameters

| Element | Amount (wt. %) |
|---|---|
| Chromium | 3-20 |
| Boron | 0-6 |
| Silicon | 0-7 |
| Iron | 0-6 |
| Phosphorus | 0-15 |
| Nickel | Balance |

The nickel-based alloy matrix, in some embodiments, is a brazing alloy. Any nickel-based brazing alloy not inconsistent with the objectives of the present can be used as the matrix in which the cemented carbide particles and alloying additive are dispersed. In some embodiments, for example, the nickel-based alloy matrix is selected from Ni-based brazing alloys of Table II:

TABLE II
Ni-Based Brazing Alloys of Matrix

| Ni-Based | |
|---|---|
| Alloy | Compositional Parameters (wt. %) |
| 1 | Ni—(14-16)% Cr—(3-4.5)% B |
| 2 | Ni—(8-10)% Cr—(1.5-2.5)% B—(3-4)% Si—(2-3)% Fe |
| 3 | Ni—(5.5-8.5)% Cr—(2.5-3.5)% B—(4-5)% Si—(2.5-4)% Fe |
| 4 | Ni—(13-15)% Cr—(9-12)% P |

Cemented carbide particles are dispersed in the nickel-based alloy matrix of the cladding. Cemented carbide particles, in some embodiments, are carbides of one or more transition metals. In one embodiment, for example, cemented carbide particles comprise cemented tungsten carbide particles. Cemented tungsten carbide particles can comprise cobalt binder. In some embodiments, tungsten carbide particles comprise cobalt binder in an amount ranging from 5 weight percent to 20 weight percent. Tungsten carbide particles of a cladding described herein, in some embodiments, comprise cobalt binder in varying amounts. In some embodiments, a first portion of tungsten carbide particles of the cladding comprise cobalt binder in an amount ranging from 5 weight percent to 10 weight percent, and a second portion of tungsten carbide particle comprise cobalt binder in an amount ranging from 10 weight percent to 15 weight percent.

In some embodiments, cemented transition metal carbide particles comprise one or more metallic elements selected from Groups IVB, VB and/or VIB of the Periodic Table. Groups of the Periodic Table described herein are identified according to the CAS designation. Cemented metal carbide particles, in some embodiments, comprise cemented titanium carbide, cemented tantalum carbide, cemented niobium carbide, cemented chromium carbide, cemented vanadium carbide, cemented tungsten carbide or cemented hafnium carbide or mixtures thereof. Binder for any of the foregoing metal carbides, in some embodiments, is cobalt binder. Alternatively, binder for the any of the foregoing metal carbides, in some embodiments, is nickel binder.

Cemented carbide particles can be present in a cladding described herein in any amount not inconsistent with the objectives of the present invention. In some embodiments, cemented carbide particles are present in an amount ranging from about 10 weight percent to about 60 weight percent of the cladding. In some embodiments, for example, cemented tungsten carbide particles, cemented titanium carbide particles, cemented chromium carbide particles or mixtures thereof are present in an amount ranging from about 10 weight percent to about 60 weight percent of the cladding. Cemented carbide particles, in some embodiments, are present in an amount ranging from about 10 weight percent to about 30 weight percent of the cladding. In some embodiments, cemented carbide particles are present in an amount ranging from about 30 weight percent to about 60 weight percent of the cladding.

Cemented carbide particles of claddings described herein can have any size not inconsistent with the objectives of the present invention. In some embodiments, cemented carbide particles have a size distribution ranging from about 5 μm to about 200 μm. Cemented carbide particles, in some embodiments, have a size distribution ranging from about 20 μm to about 150 μm. Cemented carbide particles, in some embodiments, demonstrate bimodal or multi-modal size distributions. In one embodiment, for example, cemented tungsten carbide particles display a bi-modal size distribution having cemented tungsten carbide particles of a first size distribution ranging from 20 μm to 50 μm and cemented tungsten carbide particles of a second size distribution ranging from 70 μm to 200 μm.

Claddings described herein, in some embodiments, further comprise particles of macrocrystalline tungsten carbide in addition to the cemented carbide particles. In some embodiments, macrocrystalline tungsten particles are present in amount ranging from about 5 weight percent to about 50 weight percent of the cladding. In some embodiments, macrocrystalline tungsten carbide particles are present in an amount ranging from about 5 weight percent to about 35 weight percent of the cladding. Macrocrystalline tungsten carbide particles, in some embodiments, are present in an amount ranging from about 10 weight percent to about 25 weight percent of the cladding.

In some embodiments, macrocrystalline tungsten carbide particles of a cladding have size less than 50 μm or less than 44 μm. Macrocrystalline tungsten carbide particles, in some embodiments, have a size distribution ranging from about 1 μm to about 50 μm or from about 5 μm to about 45 μm. In some embodiments, macrocrystalline tungsten carbide particles have a size distribution ranging from about 1 μm to about 10 μm. Macrocrystalline tungsten carbide particles, in some embodiments, have a size distribution of 1 μm to 6 μm or from 2 μm to 5 μm.

Claddings described herein, in some embodiments, further comprise non-macrocrystalline tungsten carbide particles in addition to the cemented carbide particles. Non-macrocrystalline tungsten carbide particles can be present in an amount ranging from 1 weight percent to 50 weight percent of the cladding. In some embodiments, non-macrocrystalline tungsten carbide particles are present in an amount ranging from about 5 weight percent to about 40 weight percent. In some embodiments, non-macrocrystalline tungsten carbide particles are present in an amount ranging from about 15 weight percent to about 35 weight percent of the cladding. Non-macrocrystalline tungsten carbide particles can have a size distribution ranging from about 1 μm to about 10 μm. In one embodiment, non-macrocrystalline tungsten carbide particles have a size distribution of 2 μm to 5 μM.

Claddings described herein, in some embodiments, further comprise other hard particles in addition to cemented carbide particles. Hard particles, in some embodiments, comprise metal carbides, metal nitrides, metal carbonitrides, metal borides, metal silicides or other ceramics or mixtures thereof. In some embodiments, metallic elements of hard particles of the cladding comprise aluminum, boron, and/or one or more metallic elements selected from Groups IVB, VB and/or VIB of the Periodic Table. For example, in some embodiments, hard particles comprise titanium carbide, titanium carbonitride, tungsten-titanium carbide, chromium carbide, titanium nitride, silicon nitride or mixtures thereof.

Hard particles can be present in claddings described herein in any amount not inconsistent with the objectives of the present invention. In some embodiments, hard particles are present in an amount ranging from about 1 weight percent to about 50 weight percent. Hard particles, in some embodiments, are present in an amount ranging from about 5 weight percent to about 40 weight percent or from about 10 weight percent to 25 weight percent.

Hard particles of a cladding described herein can have any size not inconsistent with the objectives of the present invention. In some embodiments, hard particles have a size distribution ranging from about 0.1 μm to about 1 mm. Hard particles, in some embodiments, have a size distribution ranging from about 1 μm to about 500 μm. In some embodiments, hard particles have a size distribution ranging from about 10 μm to about 300 μm. Hard particles, in some embodiments, have a size distribution ranging from about 50 μm to about 150 μm. In some embodiments, hard particles have a size distribution ranging from 10 μm to 50 μm. Hard particles can also demonstrate bimodal or multi-modal size distributions.

Claddings of composite articles described herein, in some embodiments, comprise cemented carbide particles and one or more of macrocrystalline tungsten carbide, non-macrocrystalline tungsten carbide and other hard particles. A cladding, in one embodiment, for example comprises cemented tungsten carbide particles and non-macrocrystalline tungsten carbide particles.

Further, claddings of composite articles described herein, in some embodiments, comprise cemented carbide particles and two or more of macrocrystalline tungsten carbide, non-macrocrystalline tungsten carbide and other hard particles. In some embodiments, for example, a cladding comprises cemented tungsten carbide particles, macrocrystalline tungsten carbide particles and non-macrocrystalline tungsten carbide particles. Alternatively, in some embodiments, a cladding comprises cemented tungsten carbide particles, non-macrocrystalline tungsten carbide particles and other hard particles including titanium carbide particles. Additionally, in some embodiments, a cladding comprises cemented carbide particles, macrocrystalline tungsten carbide particles, non-macrocrystalline tungsten carbide particle and other particles, including titanium carbide particles.

As described herein, claddings of composite articles also comprise an alloying additive comprising at least one of copper and molybdenum. In some embodiments, the alloying additive comprises both copper and molybdenum. Copper and/or molybdenum can be present in claddings described herein in any amount not inconsistent with the objectives of the present invention. Copper and/or molybdenum, for example, can be present in the cladding as an alloying additive in accordance with Tables III and IV respectively.

TABLE III
Amount of Cu in Cladding (wt. %)
Copper
0.3-15
0.4-13
1-12
2-10
3-8
3.4-15
4.5-15
5-15
5-12
5-10
7-15
8-13
9-12
10-15
0.1-0.8

```
TABLE IV
Amount of Mo in Cladding (wt. %)
Molybdenum
0.5-15
0.7-13
  1-15
1.5-10
4.5-15
4.5-11
  5-13
0.1-1.7
  0.1-0.75
```

In some embodiments, a cladding of a composite article described herein comprises copper and molybdenum as an alloying additive in any combination of their respective amounts provided in Tables III and IV. In some embodiments, amounts of copper and molybdenum of a cladding are selected independently of one another. Alternatively, in some embodiments, amounts of copper and molybdenum of a cladding are selected with reference to one another. As described further herein, copper and/or molybdenum of the alloying additive, in some embodiments, are discrete metal powders separate from braze powder or foil providing the nickel-based alloy matrix. In some embodiments, for example, copper powder and/or molybdenum powder is applied to the metal or alloy substrate in a carrier independent or separate from that of the nickel-based alloy powder or foil.

Claddings of composite articles described herein, in some embodiments, have compositional parameters according to Table V:

TABLE V
Cladding Compositional Parameters

| Cladding Component | Amount (wt. %) |
|---|---|
| Cemented Carbide Particles | 10-60 |
| Macrocrystalline Tungsten Carbide Particles* | 5-50 |
| Non-macrocrystalline Tungsten Carbide Particles* | 1-50 |
| Other Hard Particles* | 1-50 |
| Nickel | 20-60 |
| Chromium | 4-12 |
| Boron | 0.5-4 |
| Molybdenum | 0.5-15 |
| Copper | 0.3-15 |

*Optional component

The alloying additive of the cladding, in some embodiments, is operable to increase the corrosion resistance of the cladding, including resistance to acidic environments. Acidic environments can have a pH of less than 7, such as a pH of 1 or less. In some embodiments, for example, the alloying additive increases or facilitates increases in corrosion resistance to acidic environments comprising one or more acids selected from the group consisting of hydrochloric acid, sulfuric acid, nitric acid, phosphoric acid and/or carboxylic acids such as lactic acid, acetic acid and citric acid. In some embodiments, the alloying additive of the cladding increases or facilitates increases in corrosion resistance to environments comprising potassium oxide.

In some embodiments, a cladding having a composition according to Table V demonstrates a corrosion rate (mils per year) upon exposure to boiling hydrochloric acid (HCl) of various concentrations as set forth in Table VI. Corrosion rates provided herein are determined according to ASTM G31-72 (2004) Standard Practice for Laboratory Immersion Corrosion Testing of Metals.

TABLE VI
Cladding Corrosion Rate in HCl - mils per year (mpy)

| Corrosion Rate 1 wt. % HCl | Corrosion Rate 10 wt. % HCl |
|---|---|
| <140 | <1900 |
| <100 | <1500 |
| <80 | <1200 |
| <50 | <1000 |
| <40 | <500 |
| <30 | <300 |
| 15-50 | 200-1800 |
| 20-100 | 250-1500 |
| 40-140 | 100-500 |

Also, in some embodiments, a cladding having a composition according to Table V demonstrates a corrosion rate upon exposure to boiling sulfuric acid (H₂SO₄) of various concentrations as set forth in Table VII.

TABLE VII
Cladding Corrosion Rate in H₂SO₄ - mils per year (mpy)

| | Corrosion Rate 10 wt. % |
|---|---|
| Corrosion Rate 1 wt. % H₂SO₄ | H₂SO₄ |
| <80 | <1650 |
| <50 | <1300 |
| <30 | <1000 |
| <20 | <700 |
| <15 | <500 |
| <10 | <300 |
| 5-80 | 200-1500 |
| 10-70 | 250-1000 |
| 1-15 | 100-500 |

In some embodiments, a cladding having a composition according to Table V demonstrates a corrosion rate upon exposure to boiling lactic acid of various concentrations as set forth in Table VIII.

TABLE VIII
Cladding Corrosion Rate in Lactic Acid - mils per year (mpy)

| Corrosion Rate 10 wt. % Lactic | Corrosion Rate 80 wt. % Lactic |
|---|---|
| Acid | Acid |
| <40 | <90 |
| <35 | <80 |
| <25 | <50 |
| <15 | <20 |
| <10 | <10 |
| <5 | <5 |
| 1-40 | 1-90 |
| 5-25 | 5-50 |
| 1-5 | 1-5 |

In some embodiments, a cladding having a composition according to Table V demonstrates a corrosion rate upon exposure to boiling solutions of various chemical species as provided in Table IX.

TABLE IX
Cladding Corrosion Rate - mils per year (mpy)

| Chemical | Concentration | Corrosion | Concentration | Corrosion |
|---|---|---|---|---|
| Species | (wt. %) | Rate | (wt. %) | Rate |
| Nitric Acid | 1 | <135 | 10 | <135 |
| Phosphoric | 1 | <135 | 10 | <135 |
| Acid | | | | |
| Acetic Acid | 10 | <70 | 50 | <70 |
| Citric Acid | 10 | <70 | 80 | <70 |
| Potassium | 1 | <135 | 10 | <135 |
| Oxide | | | | |

Further, in some embodiments, a cladding having a composition according to Table V displays an average volume loss (AVL) ranging from 5.0 mm³ to 12.5 mm³ according to ASTM G65—Standard Test Method for Measuring Abrasion Using the Dry Sand/Rubber Wheel Apparatus, Procedure A. In some embodiments, a cladding having a composition according to Table V has an AVL ranging from 5.00 mm³ to 8.33 mm³ or from 5.55 mm³ to 7.70 mm³.

A cladding having a composition according to Table V, in some embodiments, demonstrates an erosion rate set forth in Table X. Erosion rates of claddings described herein are determined according to ASTM G76-07 Standard Test Method for Conducting Erosion Tests by Solid Particle Impingement Using Gas Jets.

TABLE X
Cladding Erosion Rate (mm³/g)

| Particle Impingement | 15 | 30 | 45 |
|---|---|---|---|
| Angle (degree) | Minutes | Minutes | Minutes |
| 30 | <0.0325 | <0.03 | <0.029 |
| 45 | <0.04 | <0.039 | <0.037 |
| 90 | <0.047 | <0.042 | <0.041 |

In another aspect, a composite article described herein comprises a metal or alloy substrate and a cladding adhered to the substrate, the cladding comprising a hard particle component and an alloying additive of copper dispersed in a nickel-based alloy matrix, wherein the copper is present in the cladding in an amount ranging from 3.4 weight percent to 15 weight percent. Alternatively, in some embodiments, copper is present in the cladding in an amount ranging from 0.1 weight percent to 0.8 weight percent. The alloying additive, in some embodiments, further comprises molybdenum. Molybdenum can be present in the cladding in an amount ranging from 0.1 to 1.7 weight percent or from 4.5 to 15 weight percent. In some embodiments wherein molybdenum is present in the cladding, copper is not present in the cladding.

The hard particle component can comprise particles of metal carbides, metal nitrides, metal carbonitrides, metal borides, metal silicides or other ceramics or mixtures thereof. In some embodiments, metallic elements of particles of the hard particle component comprise aluminum, boron, and/or one or more metallic elements selected from Groups IVB, VB and/or VIB of the Periodic Table. In some embodiments, the hard particle component comprises particles of macrocrystalline tungsten carbide, non-macrocrystalline tungsten carbide, titanium carbide, titanium carbonitride, tungsten-titanium carbide, chromium carbide, tantalum carbide, zirconium carbide, hafnium carbide, vanadium carbide or boron carbide or mixtures thereof. Particles of the hard particle component, in some embodiments, are nitrides of aluminum, boron, silicon, titanium, zirconium, hafnium, tantalum or niobium or mixtures thereof. Additionally, in some embodiments, particles of the hard particle component are borides such as titanium di-boride and tantalum borides or silicides such as MoSi₂. Particles of the hard particle component, in some embodiments, are cemented carbides, crushed cemented carbide, crushed carbide, crushed nitride, crushed boride or crushed silicide or combinations thereof. In some embodiments, hard particles comprise intermetallic compounds such as nickel aluminide. Further, in some embodiments, particles of the hard particle component do not include cemented carbide particles, such as cemented tungsten carbide particles.

The hard particle component, in some embodiments, is present in the cladding in an amount ranging from about 10 weight percent to about 80 weight percent of the cladding. In some embodiments, the hard particle component is present in an amount ranging from about 15 weight percent to about 70 weight percent of the cladding. The hard particle component, in some embodiments, is present in an amount ranging from about 20 weight percent to about 60 weight percent of the cladding. Further, in some embodiments, macrocrystalline tungsten carbide particles, non-macrocrystalline tungsten carbide particles and/or cemented carbide particles can be present in the cladding in any amount recited for such particles in this Section I hereinabove. In some embodiments, for example, macrocrystalline tungsten carbide particles, non-macrocrystalline tungsten carbide particles and/or cemented tungsten carbide particles are present in the cladding in an amount provided in Table IV hereinabove.

Nickel-based alloys for providing the nickel-based alloy matrix in which particles of the hard particle component are dispersed can have compositional parameters according to Tables I and/or II hereinabove. As described herein, the alloying additive dispersed in the nickel-based alloy matrix along with the hard particle component, in some embodiments, comprises copper. In some embodiments, copper is present in the cladding in an amount ranging from 0.1 weight percent to 0.8 weight percent or from 3.4 weight percent to 15 weight percent. Alternatively, in some embodiments, the alloying additive comprises molybdenum. Molybdenum, in some embodiments, is present in the cladding in an amount ranging from 0.1 to 1.7 weight percent or from about 4.5 weight percent to 15 weight percent. Moreover, in some embodiments, the alloying additive comprises copper and molybdenum. In some embodiments, copper and molybdenum are present in the cladding in amounts according to Table XI:

TABLE XI
Amount of Cu and Mo (wt. % of cladding)

| Cladding Example | Copper | Molybdenum |
|---|---|---|
| 1 | 3.4-15.0 | 4.5-15.0 |
| 2 | 3.4-15.0 | 0.1-1.7 |
| 3 | 0.1-0.8 | 4.5-15 |
| 4 | 0.1-0.8 | 0.1-1.7 |

Additionally, in some embodiments, copper and/or molybdenum are present in the cladding in any amount(s) according to Tables III and IV hereinabove.

Suitable metal or alloy substrates for claddings comprising the hard particle component and alloying additive of copper and/or molybdenum dispersed in a nickel-based alloy matrix, in some embodiments, comprise cast iron, low-carbon steels, alloy steels, tool steels or stainless steels, nickel substrates, nickel-alloy substrates, cobalt substrates or cobalt-alloy substrates.

Claddings described herein comprising a hard particle component and an alloying additive comprising copper and/or molybdenum dispersed in a nickel-based alloy matrix, in some embodiments, demonstrate a corrosion rate in boiling HCl, H₂SO₄ and lactic acid as set forth herein in Tables VI, VII and VIII respectively. In some embodiments, such claddings demonstrate a corrosion rate to boiling nitric acid, phosphoric acid, acetic acid, citric acid and aqueous solutions of potassium oxide as set forth herein in Table IX. Additionally, in some embodiments, claddings comprising a hard particle component and an alloying additive comprising copper and/or molybdenum dispersed in a nickel-based alloy matrix demonstrate an erosion rate according to Table X herein.

Claddings described in this Section I can have any desired thickness not inconsistent with the objectives of the present invention. In some embodiments, a cladding described herein has a thickness of at least about 75 μm or at least about 100 μm. In some embodiments, a cladding has a thickness ranging from about 200 μm to about 5 mm. A cladding, in some embodiments, has a thickness ranging from about 500 μm to about 3 mm or from about 750 μm to about 2 mm.

### II. Methods of Making Composite Articles

In another aspect, methods of making composite articles are described herein. In some embodiments, a method of making a composite article comprises providing a metal or alloy substrate and positioning over a surface of the substrate a particulate composition comprising a hard particle component, a nickel-based alloy matrix precursor and an alloying additive disposed in a carrier. The particulate composition is heated to provide a cladding adhered to the metal or alloy substrate, the cladding comprising the hard particle component and alloying additive dispersed in a nickel-based alloy matrix, wherein the alloying additive comprises at least one of copper and molybdenum. In some embodiments, the alloying additive comprises copper and molybdenum.

Turning now to steps of methods, methods described herein comprise providing a metal or alloy substrate. Suitable metal or alloy substrates can comprise any metal or alloy substrate described in Section I herein, including cast iron, low-carbon steels, alloy steels, tool steels, stainless steels, nickel metal, nickel alloys, cobalt metal or cobalt alloys.

A particulate composition comprising a hard particle component, an alloying additive and nickel-based alloy matrix precursor disposed in a carrier is positioned over a surface of the substrate. A carrier for the hard particle component, alloying additive and nickel-based alloy matrix precursor, in some embodiments, comprises a sheet or cloth of polymeric material. Suitable polymeric materials for use in the sheet can comprise one or more fluoropolymers including, but not limited to, polytetrafluoroethylene (PTFE).

Moreover, the hard particle component can comprise any of the hard particles described in Section I herein for the hard particle component. The hard particle component of methods described herein can comprise particles of metal carbides, metal nitrides, metal carbonitrides, metal borides, metal silicides or other ceramics or mixtures thereof. In some embodiments metallic elements of particles of the hard particle component comprise aluminum, boron, and/or one or more metallic elements selected from Groups IVB, VB and/or VIB of the Periodic Table. The hard particle component, in some embodiments, comprises particles of macrocrystalline tungsten carbide, non-macrocrystalline tungsten carbide, titanium carbide, titanium carbonitride, tungsten-titanium carbide, chromium carbide, tantalum carbide, zirconium carbide, hafnium carbide, vanadium carbide or boron carbide or mixtures thereof. Particles of the hard particle component, in some embodiments, are nitrides of aluminum, boron, silicon, titanium, zirconium, hafnium, tantalum or niobium or mixtures thereof. Additionally, in some embodiments, particles of the hard particle component are borides such as titanium di-boride and tantalum borides or silicides such as MoSi₂. Particles of the hard particle component, in some embodiments, are cemented carbides, crushed cemented carbide, crushed carbide, crushed nitride, crushed boride or crushed silicide or mixtures thereof. Further, in some embodiments, particles of the hard particle component are not cemented carbides, such as cemented tungsten carbide.

The nickel-based alloy matrix precursor can be provided as a powder having compositional parameters for producing the desired nickel-based alloy matrix of the cladding during brazing. In some embodiments, for example, compositional parameters of the nickel-based alloy matrix precursor are selected in accordance with Table I and/or II hereinabove. Similarly, copper and/or molybdenum of the alloying addition can be provided in powder form.

Hard particles, copper and/or molybdenum powder of the alloying additive and nickel-based alloy powder are combined with a polymeric powder for formation of the polymeric sheet. The hard particles, nickel-based alloy powder and copper and/or molybdenum powder can be added to the polymeric powder in accordance with the desired loadings of these species in the final cladding. In some embodiments, for example, loadings in a polymeric sheet/cloth of hard particles, nickel-based alloy powder and copper and/or molybdenum powder are selected according to the parameters of Table XII.

TABLE XII
Particle Loadings in Polymeric Sheet (wt. %)

| Particle | Loading in Polymeric Sheet |
|---|---|
| Macrocrystalline WC | 30-70 |
| Non-macrocrystalline WC | 5-50 |
| Cemented WC (Co binder) | 10-60 |
| Nickel-based alloy | 2-60 |
| Copper | 1-12 |
| Molybdenum | 1-24 |

The nickel-based alloy powder, in some embodiments, has a composition as set forth in Tables I and/or II hereinabove. Alternatively, the nickel-based alloy powder, in some embodiments, has a composition according to Table XIII.

TABLE XIII
Nickel based alloy powder

| Element | Amount (wt. %) |
|---|---|
| Chromium | 14.5-16.5 |
| Cobalt | 2.5 |
| Iron | 4.0-7.0 |
| Manganese | 1.0 |
| Molybdenum | 15.0-17.0 |
| Tungsten | 3.0-4.5 |
| Nickel | Balance |

The resulting mixture is mechanically worked or processed to trap the hard particle component, alloying additive and nickel-based alloy matrix precursor in the polymeric material. In one embodiment, for example, the desired hard particle component, alloying additive and nickel-based alloy matrix precursor are mixed with 3-15% PTFE in volume and mechanically worked to fibrillate the PTFE and trap the hard particle component, alloying additive and matrix precursor. Mechanical working can include rolling, ball milling, stretching, elongating, spreading or combinations thereof. In some embodiments, the polymeric sheet comprising the hard particle component, alloying additive and matrix alloy precursor is subjected to cold isostatic pressing. The resulting polymeric sheet comprising the hard particle component, alloying additive and alloy matrix precursor has a low elastic modulus and high green strength. A polymeric sheet comprising a hard particle component, alloying additive and alloy matrix precursor can be produced in accordance with the disclosure of one or more of U.S. Pat. Nos. 3,743,556, 3,864,124, 3,916,506, 4,194,040 and 5,352,526, each of which is incorporated herein by reference in its entirety.

Alternatively, the particulate composition comprising the hard particle component, alloying additive and nickel-based alloy matrix precursor is combined with a liquid carrier for application to the substrate. In some embodiments, for example, hard particles, copper and/or molybdenum powder and nickel alloy powder are disposed in a liquid carrier to provide a slurry or paint for application to the substrate. Suitable liquid carriers for particulate compositions described herein comprise several components including dispersion agents, thickening agents, adhesion agents, surface tension reduction agents and/or foam reduction agents. In some embodiments, suitable liquid carriers are aqueous based.

Particulate compositions disposed in a liquid carrier can be applied to surfaces of the substrate by several techniques including, but not limited to, spraying, brushing, flow coating, dipping and/or related techniques. The particulate composition of hard particles, alloying additive and alloy matrix precursor can be applied to the substrate surface in a single application or multiple applications depending on desired thickness of the coating layer. Moreover, in some embodiments, particulate compositions disposed in liquid carriers can be prepared and applied to substrate surfaces in accordance with the disclosure of U.S. Pat. No. 6,649,682 which is hereby incorporated by reference in its entirety.

Once applied to a surface of the metal or alloy substrate, the particulate composition disposed in the cloth carrier is heated to provide a cladding adhered to the metal or alloy substrate, the cladding comprising the hard particle component and alloy additive dispersed in a nickel-based alloy matrix. The particulate composition is heated above the liquidus temperature of the nickel-based matrix precursor and below the solidus temperature of the hard particle component, thereby permitting the nickel-based alloy matrix precursor to infiltrate the hard particle component, binding the hard particle component to the metal or alloy substrate in a nickel-based alloy matrix. Additionally, infiltration by the nickel-based alloy matrix precursor can disperse the alloying additive of copper and/or molybdenum throughout the cladding. The sheet or liquid carrier of the particulate composition is decomposed or burned off during the heating process.

In some embodiments, the resulting cladding is metallurgically bonded to the metal or alloy substrate. Further, in some embodiments, the cladding is fully dense or substantially fully dense.

Alternatively, in some embodiments, a method of making a composite article comprises providing a metal or alloy substrate, positioning over a surface of the substrate a particulate composition comprising a hard particle component and an alloying additive disposed in a carrier and positioning over the particulate composition a nickel-based alloy matrix precursor composition. The particulate composition and the nickel-based alloy matrix precursor composition are heated to provide a cladding adhered to the metal or alloy substrate, the cladding comprising the hard particle component and alloying additive dispersed in a nickel-based alloy matrix, wherein the alloying additive comprises at least one of copper and molybdenum. In some embodiments, the alloying additive comprises copper and molybdenum.

A metal or alloy substrate of the present method can comprise any metal or alloy substrate described in Section I herein. Moreover, the hard particle component and alloying additive of the particulate composition can comprise any of the same recited in Section I herein. Additionally, in some embodiments, the particulate composition of hard particle component and alloying additive further comprises nickel-based alloy powder. In some embodiments, for example, the nickel-based alloy powder has compositional parameters as set forth in any of Tables I, II or XIII herein. In such embodiments, the nickel-based alloy powder is provided in the carrier with the hard particle component and the alloying additive in an amount to maintain the target range of Cu and Mo described herein.

In some embodiments, a carrier of the particulate composition is a polymeric sheet or cloth. The particulate composition, for example, can be combined with a polymeric material in the formation of a sheet or cloth as described in this Section II. Further, in some embodiments, a carrier of the particulate composition is a liquid as described in this Section II.

The nickel-based alloy matrix precursor composition is positioned over the particulate composition. In some embodiments, the nickel-based alloy matrix precursor is provided as a thin sheet or foil having compositional parameters for producing the desired nickel-based alloy matrix of the cladding during brazing. In some embodiments, the nickel-based alloy matrix precursor is provided in ribbon or tape form. Alternatively, the nickel-based alloy matrix precursor composition is provided as a powder having compositional parameters for producing the desired nickel-based alloy matrix of the cladding during brazing. When in powder form, the nickel-based alloy matrix precursor can be disposed in a polymeric sheet/cloth or liquid carrier as described herein. In some embodiments, compositional parameters of the nickel-based alloy matrix precursor composition, whether foil or powder, are selected in accordance with Tables I, II and/or XIII hereinabove.

The particulate composition and the nickel-based alloy matrix precursor composition are heated to provide a cladding adhered to the metal or alloy substrate, the cladding comprising the hard particle component and alloy additive dispersed in a nickel-based alloy matrix. The particulate composition and nickel-based alloy matrix precursor composition are heated above the liquidus temperature of the alloy matrix precursor composition and below the solidus temperature of the hard particle component, thereby permitting the alloy matrix precursor composition to infiltrate the hard particle component, binding the hard particle component to the metal or alloy substrate in a nickel-based alloy matrix. Additionally, infiltration by the nickel-based alloy matrix precursor can disperse the alloying additive of copper and/or molybdenum throughout the cladding. In some embodiments, the resulting cladding is metallurgically bonded to the metal or alloy substrate. Further, in some embodiments, the cladding is fully dense or substantially fully dense.

Claddings produced in accordance with methods described herein can comprise any of the compositional parameters and physical and/or chemical properties recited in Section I above. In some embodiments, for example, copper and/or molybdenum of the alloying additive can be present in the cladding in any amount provided in Tables III, IV, V or XI herein. In some embodiments, a cladding produced in accordance with a method described herein can demonstrate one or more corrosion rates provided in Tables VI, VII VIII and/or IX herein. Further, in some embodiments, a cladding can demonstrate an erosion rate provided in Table X above.

These and other embodiments are further illustrated by the following non-limiting examples.

### Example 1

### Composite Article

A composite article having a cladding construction according to one embodiment described herein [Inventive (1)] was produced as follows. A tungsten carbide cloth preform comprising a PTFE carrier was produced having the compositional parameters of Table XIV.

TABLE XIV
Carbide Cloth Composition

| Cloth Component | Weight % |
|---|---|
| WC particles with Co binder | 30-35 |
| WC particles (2-5 μm) | 45-55 |
| Nickel-based alloy | 7-10 |
| Molybdenum | 3-6 |
| Copper | 1-3 |
| PTFE | 0.5-1.0 |

A second PTFE cloth preform comprising a nickel-based alloy braze powder was provided, wherein the nickel-based alloy braze powder had a composition of 14-16% chromium, 3-5% boron and the balance nickel. The WC carbide cloth preform was applied to the surface of a CA6NM casting substrate with adhesive. The second braze cloth preform was adhered over the WC carbide cloth preform. The resulting assembly was heated in a vacuum furnace to 1100° C.-1160° C. for approximately 15 minutes to 4 hours during which time the nickel-based alloy braze powder of the second cloth preform melted and infiltrated the WC cloth preform producing a cladding described herein comprising WC-Co particles, WC particles and an alloying additive of Cu and Mo dispersed in a nickel-based alloy matrix metallurgically bonded to the CA6NM casting substrate.

A composite article having a comparative cladding construction [Comparative (1)] was produced according to the same protocol, the difference being the absence of copper in the cladding. The compositional parameters of the inventive and comparative claddings are provided in Table XV.

TABLE XV
Cladding Compositional Parameters (wt. %)

| Component | Inventive (1) | Comparative (1) |
|---|---|---|
| WC-Co particles (−325 mesh) | 20.0-22.0 | 19.0-22.0 |
| WC particles (2-5 μm) | 30.0-34.0 | 29.5-33.0 |
| Nickel | 30.0-54.5 | 34.5-54.5 |
| Chromium | 6.0-10.3 | 6.5-10.25 |
| Boron | 1.4-2.6 | 1.4-2.7 |
| Molybdenum | 2.1-4.0 | 1.5-2.2 |
| Copper | 0.7-1.4 | — |

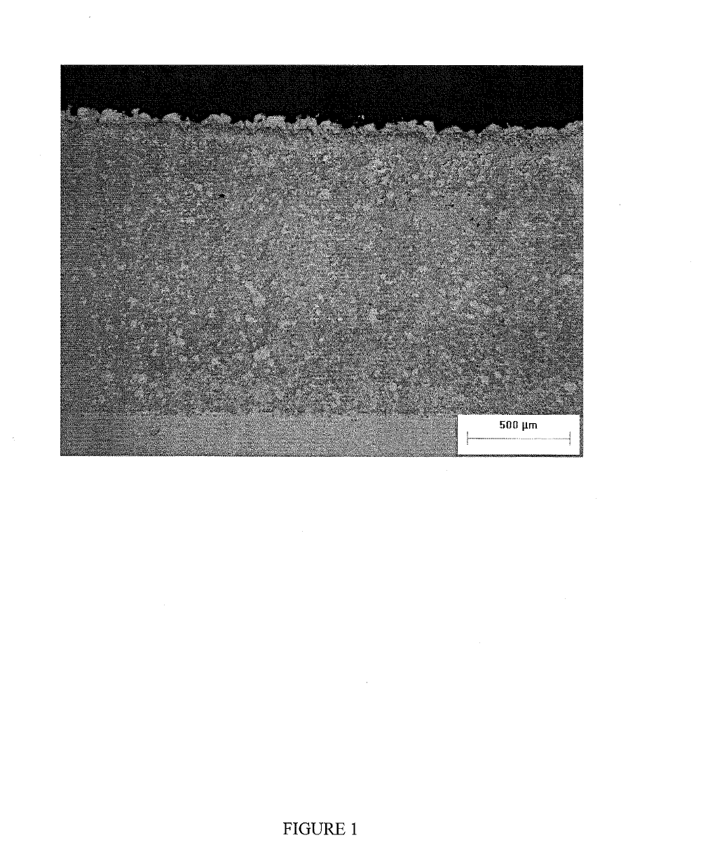

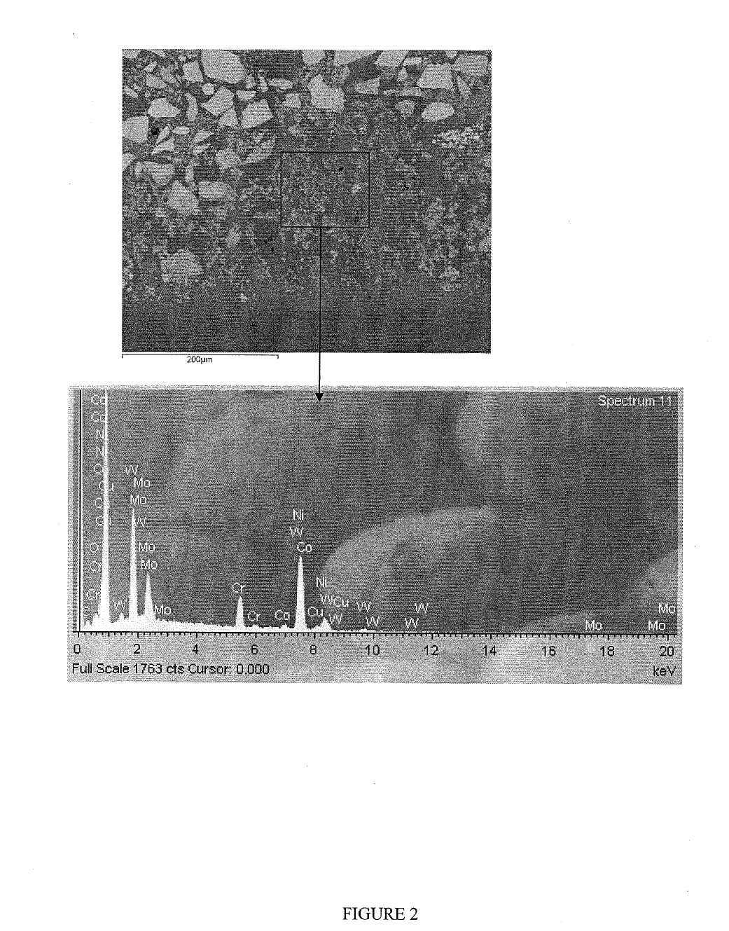

The Inventive (1) cladding microstructure is illustrated in the cross-sectional metallography of FIG. 1. Moreover, FIG. 2 illustrates bulk metal compositional parameters of the Inventive (1) cladding according to energy dispersive X-ray spectroscopy (EDX). The presence of copper and molybdenum alloying additive is demonstrated in the spectrograph. Cobalt from the cemented WC particles is also evident.

Claddings of Inventive (1) composite articles and Comparative (1) composite articles were subjected to testing including abrasion resistance, erosion resistance and corrosion resistance. Abrasion resistance testing was administered in accordance with ASTM G65—Standard Test Method for Measuring Abrasion Using the Dry Sand/Rubber Wheel Apparatus, Procedure A. The Inventive (1) cladding demonstrated an AVL of 11.63 mm³, and the Comparative (1) cladding demonstrated an AVL of 11.11 mm³.

Erosion resistance testing of the claddings was administered in accordance with ASTM G76-07 Standard Test Method for Conducting Erosion Tests by Solid Particle Impingement Using Gas Jets. Three particle impingement angles were used in addition to three durations. The results of the erosion testing for the Inventive (1) cladding and Comparative (1) cladding are provided in Tables XVI and XVII.

TABLE XVI
Erosion Rate for Inventive (1) Cladding (mm³/g)

| Particle Impingement | | | |
|---|---|---|---|
| Angle (degree) | 15 Minutes | 30 Minutes | 45 Minutes |
| 30 | 0.0282 | 0.0262 | 0.0255 |
| 45 | 0.0349 | 0.0337 | 0.0324 |
| 90 | 0.041 | 0.0364 | 0.0359 |

TABLE XVII
Erosion Rate for Comparative (1) Cladding (mm³/g)

| Particle Impingement | | | |
|---|---|---|---|
| Angle (degree) | 15 Minutes | 30 Minutes | 45 Minutes |
| 30 | 0.0253 | 0.0244 | 0.0243 |
| 45 | 0.0295 | 0.0289 | 0.0301 |
| 90 | 0.0358 | 0.036 | 0.036 |

Corrosion resistance testing of the claddings was administered in accordance with ASTM G31-72 (2004) Standard Practice for Laboratory Immersion Corrosion Testing of Metals. Testing was conducted at boiling temperatures of the corresponding acids. Results of the corrosion resistance testing for the Inventive (1) cladding and Comparative (1) cladding are provided in Tables XVIII and XIX.

TABLE XVIII
Corrosion Rate for Inventive (1) Cladding (mpy)

| | Concentration | Corrosion | Concentration | Corrosion |
|---|---|---|---|---|
| Acid | (wt. %) | rate | (wt. %) | rate |
| HCl | 1 | 21.24 | 10 | 263.08 |
| H₂SO₄ | 1 | 7.90 | 10 | 265.14 |
| Lactic Acid | 10 | 3.36 | 80 | 3.89 |

TABLE XIX
Corrosion Rate for Comparative (1) Cladding (mpy)

| | Concentration | Corrosion | Concentration | Corrosion |
|---|---|---|---|---|
| Acid | (wt. %) | rate | (wt. %) | rate |
| HCl | 1 | 116.44 | 10 | 1208.05 |
| H₂SO₄ | 1 | 59.95 | 10 | 1291.25 |
| Lactic Acid | 10 | 18.18 | 80 | 48.16 |

As provided in Tables XVIII and XIX, claddings described herein comprising the alloying additive of copper and molybdenum displayed enhanced corrosion resistance in highly acidic environments.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

That which is claimed is:

1. A composite article comprising:
a metal or alloy substrate; and
a cladding adhered to the substrate, the cladding comprising cemented carbide particles and an alloying additive dispersed in a nickel-based alloy matrix, the alloying additive comprising copper and molybdenum, wherein the cladding demonstrates a corrosion rate of less than 140 mils per year (mpy) in boiling 1 weight percent hydrochloric acid determined according to ASTM G31-72 (2004).

2. The composite article of claim 1, wherein the cemented carbide particles comprise tungsten carbide particles with cobalt binder.

3. The composite article of claim 2, wherein the tungsten carbide particles with cobalt binder are present in an amount ranging from about 10 weight percent to about 60 weight percent of the cladding.

4. The composite article of claim 1, wherein the cladding further comprises non-macrocrystalline tungsten carbide particles having a size ranging from 2 μm to 5 μm.

5. The composite article of claim 1, wherein the cladding further comprises macrocrystalline tungsten carbide particles.

6. The composite article of claim 2, wherein the corrosion rate of the cladding ranges from 20 to 100 mpy.

7. The composite article of claim 2, wherein the corrosion rate of the cladding ranges from 15 to 50 mpy.

8. The composite article of claim 1, wherein the copper is present in an amount of 0.3 to 15 weight percent and the molybdenum is present in an amount of 0.5 to 15 weight percent of the cladding.

9. The composite article of claim 1, wherein the copper is present in an amount of 3.4 to 15 weight percent and the molybdenum is present in an amount of 4.5 to 15 weight percent of the cladding.

10. The composite article of claim 1, wherein the cladding demonstrates an erosion rate of less than 0.04 mm³/g according to ASTM G76-07 using a particle impingement angle of 90 degrees and a duration of 45 minutes.

11. The composite article of claim 1, wherein the cladding is metallurgically bonded to the substrate.

12. The composite article of claim 1, wherein the cladding has a thickness of 100 μm to 3 mm.

13. The composite article of claim 1, wherein the metal or alloy substrate is selected from the group consisting of nickel metal, nickel-based alloy, iron-based alloy, cobalt metal and cobalt-based alloy.

14. The composite article of claim 1, wherein the substrate is selected from the group consisting of cast iron, low-carbon steel, alloy steel, tool steel and stainless steel.

15. A composite article comprising:
a metal or alloy substrate; and
a cladding adhered to the substrate, the cladding comprising a hard particle component and an alloying additive comprising copper and molybdenum dispersed in a nickel-based alloy matrix, wherein the copper is present in an amount ranging from 3.4 to 15 weight percent of the cladding.

16. The composite article of claim 15, wherein the molybdenum is present in an amount ranging from 0.5 to 15 weight percent of the cladding.

17. The composite article of claim 15, wherein the molybdenum is present in an amount ranging from 5 to 13 weight percent of the cladding.

18. The composite article of claim 15, wherein the hard particle component comprises macrocrystalline tungsten carbide particles, non-macrocrystalline tungsten carbide particles or mixtures thereof.

19. The composite article of claim 15, wherein the hard particle component comprises particles of metal carbides, metal nitrides, metal carbonitrides, metal borides, metal silicides or mixtures thereof.

20. The composite article of claim 19, wherein metallic elements of the particles are selected from the group consisting of aluminum, boron and metallic elements of Groups IVB, VB and VIB of the Periodic Table.

21. The composite article of claim 18, wherein the hard particle component further comprises titanium carbide particles.

22. The composite article of claim 15, wherein the cladding demonstrates a corrosion rate of less than 140 mils per year in boiling 1 weight percent hydrochloric acid determined according to ASTM G31-72 (2004).

23. A method of making a composite article comprising:
providing a metal or alloy substrate;
positioning over a surface of the substrate a particulate composition comprising a hard particle component, a nickel-based alloy precursor and an alloying additive of copper and molybdenum disposed in a carrier; and
heating the particulate composition to provide a cladding adhered to the substrate, the cladding comprising the hard particle component and alloying additive dispersed in a nickel-based alloy matrix, wherein the hard particle component comprises cemented carbide particles and the cladding demonstrates a corrosion rate of less than 140 mils per year (mpy) in boiling 1 weight percent hydrochloric acid determined according to ASTM G31-72 (2004).

24. The method of claim 23, wherein the cemented carbide particles comprise tungsten carbide particles with cobalt binder.

25. The method of claim 23, wherein the hard particle component further comprises macrocrystalline tungsten carbide particles.

26. The method of claim 23, wherein the corrosion rate of the cladding ranges from 20-100 mpy.

27. The method of claim 23, wherein the copper is present in an amount of 0.3 to 15 weight percent and the molybdenum is present in an amount of 0.5 to 15 weight percent of the cladding.

28. The method of claim 23, wherein the copper is present in an amount of 3.4 to 15 weight percent and the molybdenum is present in an amount of 4.5 to 15 weight percent of the cladding.

29. A method of making a composite article comprising:
providing a metal or alloy substrate;
positioning over a surface of the substrate a particulate composition comprising a hard particle component and an alloying additive of copper and molybdenum disposed in a carrier;
positioning over the particulate composition a nickel-based alloy matrix precursor composition; and
heating the particulate composition and nickel-based alloy matrix precursor composition to provide a cladding adhered to the substrate, the cladding comprising the hard particle component and alloying additive dispersed in a nickel-based alloy matrix, wherein the hard particle component comprises cemented carbide particles and the cladding demonstrates a corrosion rate of less than 140 mils per year (mpy) in boiling 1 weight percent hydrochloric acid determined according to ASTM G31-72 (2004).

30. The method of claim 29, wherein the cemented carbide particles comprise tungsten carbide particles with cobalt binder.

31. The method of claim 29, wherein the copper is present in an amount of 0.3 to 15 weight percent and the molybdenum is present in an amount of 0.5 to 15 weight percent of the cladding.

32. The method of claim 29, wherein the copper is present in an amount of 3.4 to 15 weight percent and the molybdenum is present in an amount of 4.5 to 15 weight percent of the cladding.
